(19) United States
(12) Patent Application Publication
(10) Pub. No.: US 2024/0383027 A1
(43) Pub. Date: Nov. 21, 2024

(54) EFFICIENT IDENTIFICATION OF FLATNESS IN A PLANAR ROLLING MATERIAL

(71) Applicant: Primetals Technologies Germany GmbH, Erlangen (DE)

(72) Inventors: Martin KERSCHENSTEINER, Berg (DE); Alexander THEKALE, Erlangen (DE)

(21) Appl. No.: 18/692,302

(22) PCT Filed: Aug. 9, 2022
(86) PCT No.: PCT/EP2022/072288

§ 371 Date: Mar. 14, 2024

(30) Foreign Application Priority Data
Sep. 16, 2021 (EP) 21197209.6

(51) Int. Cl. B21B 37/24; G06T 7/00

(52) U.S. Cl. CPC B21B 37/24; G06T 7/0004; G06T 2207/30136

(57) ABSTRACT

An evaluation device that determines, based on data acquired by an acquisition device, an error value (PF) relating to the flatness of a strip of a rolling material exiting a roll stand, and supplies the determined error values (PF) to a control device, which takes the error values (PF) into account when determining adjustment variables(S) for flatness control elements of the roll stand. The interaction of the acquisition device, the evaluation device, the control device and the roll stand results in a closed control loop working in real time. In order to determine the particular error value (PF) of the strip, the evaluation device performs a local frequency analysis of the data and determines the particular error value (PF) on the basis of the local frequency analysis.

### TECHNICAL FIELD

The present invention proceeds from an operating method for a roller assembly,
wherein a planar rolling material of metal which extends in a width direction over a rolling material width is rolled by means of a roll stand of the roller assembly, wherein the planar rolling material leaves the roll stand in a transport direction after it has been rolled,
wherein at least one two-dimensional data set of the surface of the planar rolling material is iteratively repeatedly acquired on the output side of the roll stand by means of an acquisition device which works contactlessly and without mechanical action on the planar rolling material, the values of which data set are dependent at least on the external flatness prevailing locally at the respective corresponding location of the planar rolling material,
wherein the respective two-dimensional data set is received by an evaluation device of the roller assembly,
wherein the evaluation device, for strips of the planar rolling material running in the transport direction, and using strips of the respective two-dimensional data set that correspond to the strips, determines an error value which relates to the respective strip and is dependent on the flatness error,
wherein the evaluation device supplies the determined error values to a control device of the roller assembly, which in turn takes the determined error values into consideration in the determination of control variables for flatness control elements of the roll stand,
so that, as a result of the cooperation of the acquisition device, the evaluation device, the control device and the roll stand, a closed feedback control loop which works in real time is obtained.

In order that the feedback control loop can work in real time, the mentioned components of the roller assembly must perform their functions repeatedly with a fixed work cycle. The work cycle is generally in the millisecond range, mostly in the two-digit millisecond range, in exceptional cases in the lower three-digit millisecond range. This is the case both in the prior art and within the scope of the present invention.

The present invention further proceeds from a computer program, wherein the computer program comprises machine code which can be processed directly by an evaluation device of a roller assembly, wherein the processing of the machine code by the evaluation device has the effect that the evaluation device, during operation of a roll stand in which a planar rolling material of metal is rolled and from which the planar rolling material exits in a transport direction after it has been rolled, cooperates with a control device of the roll stand and with an acquisition device which works contactlessly and without mechanical action on the planar rolling material, such that it iteratively repeatedly
receives from the acquisition device at least one two-dimensional data set, acquired by the acquisition device, of the surface of the planar rolling material on the output side of the roll stand, wherein the values of the respective two-dimensional data set are dependent at least on the external flatness prevailing locally at the respective corresponding location of the planar rolling material,
determines, for strips of the planar rolling material running in the transport direction, and using strips of the respective two-dimensional data set that correspond to the strips, an error value which relates to the respective strip and is dependent on the flatness error, and
supplies the determined error values to the control device for consideration in the determination of control variables for flatness control elements of the roll stand, so that, as a result of the cooperation of the acquisition device, the evaluation device and the control device, a closed feedback control loop which works in real time is obtained.

The present invention proceeds further from an evaluation device of a roller assembly, wherein the evaluation device is programed with such a computer program, so that the evaluation device cooperates with an acquisition device and with a control device of a roll stand of a roller assembly in accordance with such an operating method.

The present invention proceeds further from a roller assembly,
wherein the roller assembly has a roll stand which comprises flatness control elements and by means of which a planar rolling material of metal which extends in a width direction over a rolling material width is rolled, wherein the planar rolling material leaves the roll stand in a transport direction after it has been rolled,
wherein the roller assembly has an acquisition device which works contactlessly and without mechanical action on the planar rolling material and by means of which at least one two-dimensional data set of the surface of the planar rolling material is iteratively repeatedly acquired on the output side of the roll stand, the values of which data set are dependent at least on the external flatness prevailing locally at the respective corresponding location of the planar rolling material,
the roller assembly has an evaluation device which is connected for data transfer to the acquisition device for the repeated receiving of two-dimensional data sets, acquired by means of the acquisition device, of the surface of the planar rolling material and which determines, for strips of the planar rolling material running the transport direction, and using strips of the respective two-dimensional data set that correspond to the strips, an error value which relates to the respective strip and is dependent on the flatness error, and which supplies the determined error values to a control device of the roller assembly,
wherein the control device takes the determined error values into consideration in the determination of control variables for the flatness control elements of the roll stand.

### PRIOR ART

Such an operating method and the associated corresponding articles are known from US 2015/0 116 727 A1. In particular, it is known from US 2015/0 116 727 A1 to acquire images of a respective portion of a metal band line by line by means of one or more cameras. During the acquisition of each line, the corresponding region of the metal band is illuminated with a uniform intensity. By the repeated acquisition of lines, a two-dimensional image of the surface of the metal band is generated. The image is divided into individual strips. The strips can run in the longitudinal direction of the rolling material. They are evaluated in terms of whether hollow bumps are identified therein. If such hollow bumps are identified, this is recorded as a local flatness error. The determined flatness errors can be supplied to an upstream roll stand as correction values for determining the activation of the flatness control elements thereof.

It is known from WO 2019/068 376 A1 to acquire the flatness of a metal band on the output side of a roll stand in a spatially resolved manner over the width of the metal band by means of a segmented measuring roller. Control elements of the roll stand are activated in dependence on the acquired flatness in order to bring the flatness as close to a desired flatness as possible.

It is known from WO 2021/105 364 A2 to acquire images of the surface of a metal band by means of a camera and to determine the local surface condition by evaluating the images. The surface roughness, hollow bumps, the color, the brightness, the chemical composition and other properties of the surface are mentioned as examples of the local surface condition. Based on the determined local surface condition, the control of an upstream device is influenced. The device can be a cold rolling mill.

JP H04 279 208 A discloses an operating method for a roller assembly, wherein a planar rolling material of metal which extends over a rolling material width is rolled by means of a roll stand, wherein the planar rolling material leaves the roll stand in a transport direction after it has been rolled. By means of a camera, an image of the surface of the planar rolling material is iteratively repeatedly acquired on the output side of the roll stand, the values of which are dependent on the external flatness prevailing locally at the respective corresponding location of the planar rolling material. The image is supplied to an evaluation device, which determines therefrom error values for the flatness of strips of the planar rolling material which run in the transport direction. The evaluation device supplies the determined error values to a control device, which takes the error values into consideration in the determination of control variables for flatness control elements of the roll stand. Thus, as a result of the cooperation of the acquisition device, the evaluation device, the control device and the roll stand, a closed feedback control loop which works in real time is obtained. In order to determine the error value, the evaluation device performs a local frequency analysis of the respective two-dimensional data set and determines the respective error value on the basis of the local frequency analysis.

EP 2 258 492 A1 discloses an operating method for a roller assembly, in which a planar rolling material of metal which extends in a width direction over a rolling material width is rolled by means of a roll stand, wherein the planar rolling material leaves the roll stand in a transport direction after it has been rolled. By means of an acquisition device which works contactlessly and without mechanical action on the planar rolling material, at least one two-dimensional data set of the surface of the planar rolling material is iteratively repeatedly acquired on the output side of the roll stand, the values of which data set are dependent on the external flatness prevailing locally at the respective corresponding location of the planar rolling material and/or on the internal stress prevailing locally at the respective corresponding location of the planar rolling material. The respective two-dimensional data set is received by an evaluation device of the roller assembly. For strips of the planar rolling material running in the transport direction, the evaluation device determines an error value which relates to the respective strip and is dependent on the flatness error. The evaluation device supplies the determined error values to a control device of the roller assembly, which in turn takes the determined error values into consideration in the determination of control variables for flatness control elements of the roll stand. Thus, as a result of the cooperation of the detection device, the evaluation device, the control device and the roll stand, a closed feedback control loop which works in real time is obtained.

### SUMMARY OF THE INVENTION

When rolling a planar rolling material of metal, for example a metal band, it is continuously endeavored to produce a planar rolling material h is both stress-free in itself and distortion-free on the outside and thus flat. If a planar rolling material, when seen in the width direction, is rolled completely uniformly, that is to say with a consistent relative reduction per pass when seen in the width direction, this is the case. If rolling is not uniform in the width direction, some longitudinal strips (when seen in the width direction) of the planar rolling material are rolled less intensively than other longitudinal strips of the planar rolling material. The planar rolling material therefore forms waves in the more intensively rolled longitudinal strips. It becomes non-flat, the external (=visible) flatness is other than 0. Although the external flatness is equal to 0 in the case of small length differences or when the planar rolling material is subject to tension, the length differences result in internal tensile stress differences when the rolling material is subject to tension. In this case, the internal stress of the planar rolling material is thus other than 0.

Various procedures are known in the prior art for equalizing and compensating for flatness errors. Reference may be made to US 2015/0 116 727 A1, which has already been mentioned, and also to WO 2019/068 376 A1, which has likewise already been mentioned.

The environmental conditions when rolling a planar rolling material of metal are often challenging, for example as a result of high temperatures, vibration, water or water vapor, oil vapors, and dirt and rust particles. This impedes the operation of measuring devices for acquiring error values and often leads to a high space requirement.

The object of the present invention consists in providing possibilities by means of which flatness errors of the planar rolling material can be identified and corrected in a simple and reliable manner.

The object is achieved by an operating method having the features of claim 1. Advantageous embodiments of the operating method are the subject matter of dependent claims 2 to 12.

According to the invention, an operating method of the type mentioned at the beginning is configured such h that the evaluation device, for determining the respective error value of a strip, determines intensities and spatial frequencies of local oscillations of the data values of the strip of the respective two-dimensional data set that corresponds to the respective strip and determines the respective error value on the basis of the intensities and/or the spatial frequencies.

The intensities and spatial frequencies can be determined, for example, by means of a Fourier transform of the data values.

In the simplest case, the acquisition device is in the form of a camera device by means of which a respective two-dimensional image of the surface of the planar rolling material is acquired as the respective two-dimensional data set or is determined on the basis of acquired image data. The camera device can in particular be in the form of a “normal” camera, by means of which a two-dimensional image is acquired directly. Alternatively, a plurality of such cameras can also be used, so that a plurality of two-dimensional data sets can accordingly also be acquired. The camera device can also be a line-scan camera. Alternatively, a plurality of such line-scan cameras can also be used. Cameras which can be used in rolling mills are generally known to those skilled in the art. They can be used-depending on the form of the camera—to detect light in the visible spectrum and/or in the infrared range. From the structural point of view, the camera can be in the form of, for example, a CCD camera.

The acquired images can be normal intensity images. Alternatively, they can be so-called depth images, in which depth information is also associated with the respective location in the two-dimensional image or data set, so that a three-dimensional image is ultimately obtained. Optionally, a plurality of “normal” two-dimensional images can be acquired by a plurality of cameras, from which a depth image is determined, for example by fusion of the acquired images, and transmitted to the evaluation device.

It is possible that the camera device has an associated lighting device, by means of which the image region acquired by means of the camera device is illuminated in a defined manner. Optionally, the lighting device can modulate the illumination of the acquired image region. As a result, the signal-to-noise ratio can be improved in some circumstances.

Preferably, by means of the two-dimensional data sets, the surface of the planar rolling material is acquired over the entire width of the planar rolling material. As a result, the evaluation of the respective two-dimensional data set can be improved.

The expression “over the entire width” implies that the two-dimensional data sets also include the lateral edges of the planar rolling material. Thus, within the scope of the evaluation of the two-dimensional data sets, in particular the position of the lateral edges can also be taken into consideration.

Preferably, the acquisition device, when seen in a plane defined by the width direction and the transport direction, is arranged centrally above the planar rolling material. The arrangement of the acquisition device can thus be such that a line which runs from the acquisition device to the planar rolling material and is oriented orthogonally to the surface of the planar rolling material meets the planar rolling material centrally. In this case, the acquisition device is arranged directly or almost directly above the planar rolling material, or the acquired region of the planar rolling material.

In many cases, the flatness control elements of the roll stand comprise locally acting control elements by means of which in each case only a portion of the upper working roller and/or of the lower working roller of the roll stand is influenced. Such control elements that act only locally can in particular be cooling devices by means of which a coolant can be applied only to the respective portion of the corresponding working roller. When locally acting control elements are present, the strips of the planar rolling material preferably each correspond to a portion of the upper working roller and/or of the lower working roller. As a result, a 1:1 relationship between determined error values on the one hand and associated control variables for the locally acting control elements can be established.

Preferably, the evaluation device, for determining the respective error value of a strip, selects a segment of the respective strip, wherein the segment, when seen in the transport direction of the planar rolling material, extends over the entire length of the respective strip and, when seen in the width direction of the planar rolling material, extends over only part of the width of the respective strip. In this case, the evaluation device determines the intensities and the spatial frequencies only in respect of the segment of the respective strip. This simplifies the determination of the respective error value.

It is possible that the evaluation device carries out pre-processing of the respective two-dimensional data set prior to the determination of the intensities and spatial frequencies.

The pre-processing can be, for example, a smoothing (frequency filtering). Alternatively or in addition, it can be the elimination of artefacts. The artefacts can be, for example, errors caused by the acquisition arrangement as such. Alternatively, the artefacts can be caused, for example, by substances (for example scale) on the surface. It is also possible to perform an identification of the lateral edges of the planar rolling material and to take the position thereof into consideration in the evaluation of the two-dimensional data set. In particular, it is possible that only strips that are located wholly within the lateral edges of the planar rolling material are formed and/or evaluated. Alternatively, it is also possible to perform the evaluation only when a segment of a respective strip that is used for determining the error value is located wholly within the lateral edges of the planar rolling material.

The data values are often intensity values. In such cases, the pre-processing can comprise normalization of the intensity values in respect of the maximum possible value range of the values of the two-dimensional data set and, based on the respective strip or a segment of the respective strip, adjustment by the mean of the data values of the respective strip or segment. As a result, the evaluation is standardized.

It is likewise possible that the evaluation device performs a plausibility check of the error values between the determination of the intensities and the spatial frequencies and the determination of the respective error value. If the strips have only a relatively small width, the error values of adjacent strips can be compared with one another, for example. If the error value determined for a particular strip differs significantly from the determined error values of the adjacent strips, then this can indicate an incorrect evaluation. Likewise, it can indicate an incorrect evaluation if determined spatial frequencies for adjacent strips differ significantly from one another. Reasons for such differences may be, for example, scale patches. Also, the error values, when seen over a plurality of strips, should exhibit a value distribution which is similar to a bell-shaped curve, in particular a Gaussian distribution.

Preferably, the evaluation device determines the respective error value using at least the intensity and/or the spatial frequency of the greatest local oscillation. In the simplest case, solely the intensity of the greatest local oscillation can be used, for example. Alternatively, it is possible that solely the spatial frequency of the greatest local oscillation is used. Preferably, however, the respective error value is determined on the basis of the intensity and the spatial frequency of the greatest local oscillation in combination. In any case, it is possible to store corresponding characteristic curves in the evaluation device.

The planar rolling material can be hot rolled or cold rolled in the roll stand, as required.

Generally, there is no other roll stand between the roll stand of the roller assembly and the acquisition device. This is the case regardless of whether the roll stand of the roller assembly is the only roll stand of a rolling mill, the last roll stand of a multi-stand rolling-mill train, or a roll stand other than the last roll stand of a multi-stand rolling-mill train.

The object is further achieved by a computer program having the features of claim 13. According to the invention, the processing of the computer program has the effect that the evaluation device, for determining the respective error value of a strip, determines intensities and spatial frequencies of local oscillations of the data values of the strip of the respective two-dimensional data set that corresponds to the respective strip and determines the respective error value on the basis of the intensities and/or the spatial frequencies.

The processing of the computer program can further also have the effect that the evaluation device carries out some of the above-mentioned advantageous embodiments of the operating method.

The object is further achieved by an evaluation device having the features of claim 15. According to the invention, the evaluation device is programed with a computer program according to the invention, so that the evaluation device cooperates with an acquisition device and with a control device of a roll stand of a roller assembly in accordance with an operating method according to the invention.

The object is further achieved by a roller assembly having the features of claim 16. According to the invention, the evaluation device of the roller assembly is in the form of the evaluation device according to the invention.

### BRIEF DESCRIPTION OF THE DRAWINGS

The above-described properties, features and advantages of this invention and the manner in which they are achieved will be more clearly and distinctly understandable in conjunction with the following description of the exemplary embodiments, which are explained in greater detail in conjunction with the drawings, which show, in schematic form:

FIG. 1 a roller assembly from the side,

FIG. 2 the roller assembly of FIG. 1 from above,

FIG. 3 a two-dimensional data set,

FIG. 4 a flow diagram,

FIG. 5 a two-dimensional data set,

FIG. 6 a flow diagram,

FIG. 7 a segment,

FIG. 8 a flow diagram,

FIG. 9 a profile of data values,

FIG. 10 a local spectrum,

FIG. 11 a rolling material with non-flat regions,

FIG. 12 a single step of a flow diagram,

FIG. 13 a multi-stand rolling-mill train, and

FIG. 14 a multi-stand rolling-mill train.

### DESCRIPTION OF THE EMBODIMENTS

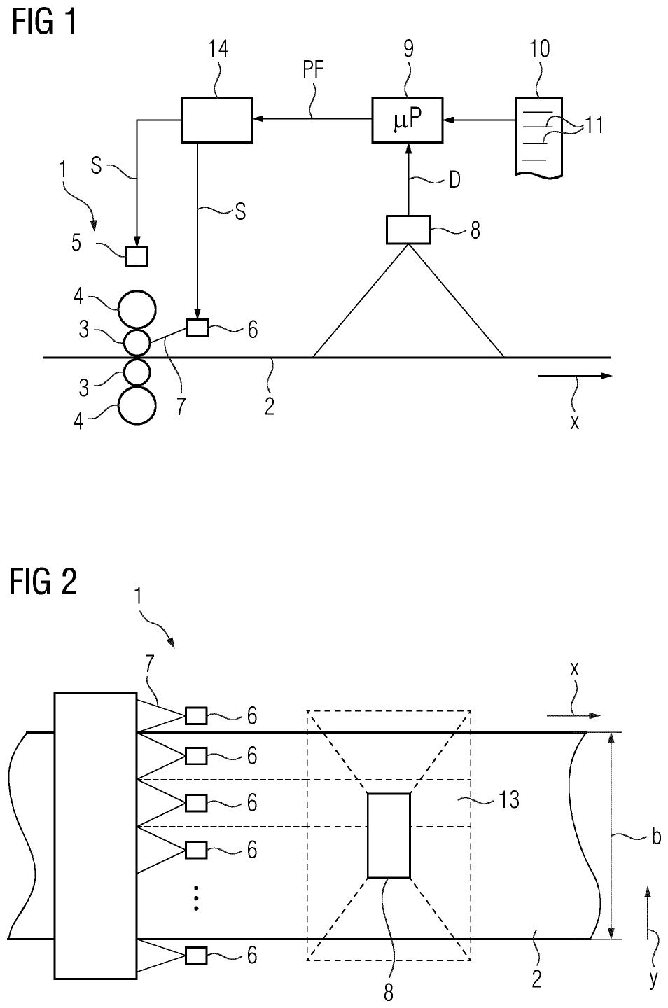

According to FIGS. 1 and 2, a roller assembly has a roll stand 1. By means of the roll stand 1, a rolling material 2 is rolled. After being rolled in the roll stand 1, the rolling material 2 leaves the roll stand 1 in a transport direction x.

The rolling material 2 consists of metal, often of steel. Alternatively, the rolling material 2 can consist, for example, of aluminum or copper. It is possible that the rolling material 2 is cold rolled in the roll stand 1. Generally, however, it is hot rolled.

According to the illustration in FIG. 2, the rolling material 2 is a planar rolling material, that is to say a band or a thick plate. This also follows implicitly from the illustration of the roll stand 1 in FIG. 1 as a roll stand which has, in addition to its working rollers 3, further rollers 4, in particular supporting rollers. The rolling material 2 extends in a width direction y over a rolling material width b.

The roll stand 1 comprises generally acting flatness control elements 5 and/or locally acting flatness control elements 6. The flatness of the rolling material 2 leaving the roll stand 2 can be adjusted both by means of the generally acting flatness control elements 5 and by means of the locally acting flatness control elements 6. The generally acting flatness control elements 5 are control elements the activation of which necessarily influences the flatness of the rolling material 2 over the entire rolling material width b. Examples of such control elements are a bending device for bending the working rollers 3, a pushing device for axially displacing the working rollers 3 and/or the further rollers 4, and other control elements, for example control elements for a so-called pair crossing. The locally acting flatness control elements 6 can be present as an alternative or in addition to the generally acting flatness control elements 5. By means of the locally acting flatness control elements 6, an individual portion of the upper working roller 3 and/or of the lower working roller 3 can be influenced individually. This is shown in FIG. 2 for the upper working roller 3. Such control elements that act only locally can in particular be cooling devices by means of which a coolant 7 can be applied only to the respective portion of the corresponding working roller 3.

The roller assembly further has an acquisition device 8. According to the illustration in FIG. 2, the acquisition device 8, when seen in a plane defined by the width direction y and the transport direction x, is preferably arranged centrally above the rolling material 2. Generally, there is no other roll stand between the roll stand 1 and the acquisition device 8.

By means of the acquisition device 8, at least one two-dimensional data set D of the surface of the rolling material 2 is iteratively repeatedly acquired-mostly with a fixed cycle time T (see FIG. 4). The cycle time T can correspond to an image rate of several images/s, for example 24 images/s, 30 images/s or 60 images/s. Other values are also possible. As a result of the arrangement of the acquisition device 8 on the output side of the roll stand 1, the data set D also relates to the rolling material 2 on the output side of the roll stand 1.

The acquisition device 8 works contactlessly and without mechanical action on the rolling material 2. For example, the acquisition device 8 can be in the form of a camera device by means of which a respective two-dimensional image of the surface of the rolling material 2 is acquired as the respective two-dimensional data set D. In the case of a plurality of cameras, the acquisition device 8 can either use the two-dimensional data sets D supplied by the cameras as such or can determine, on the basis of acquired image data of the plurality of cameras, a resulting two-dimensional image of the surface of the rolling material 2 as the resulting two-dimensional data set D. Reference is made to the corresponding comments n the introduction to the description. If required, a lighting device—which optionally works in a modulated manner—can further be associated with the camera device.

The data sets D can arise individually or continuously. In the case where the acquisition device 8 is in the form of a camera device, the transmitted data sets D, or images, can be, for example, individual images in JPEG format or another suitable format or continuously arising video images, for example in MPEG format or mp4 format.

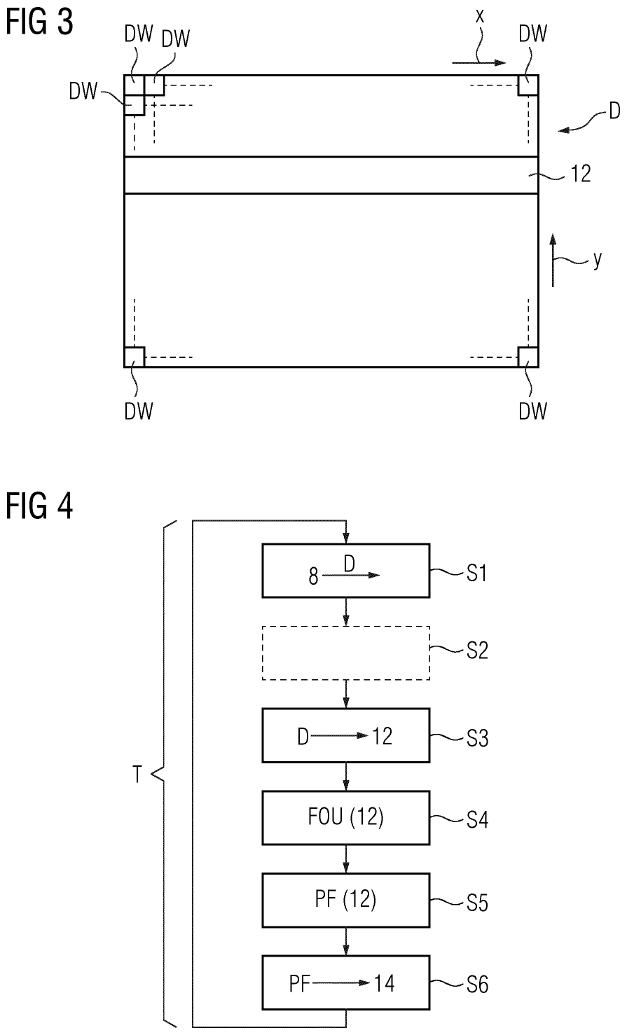

According to FIG. 3, the data set D comprises a large number of data values DW. Only some of the data values DW are shown in

FIG. 3 so as not to overload FIG. 3 unnecessarily. Regardless of the concrete form of the acquisition device 8, however, the individual data values DW correspond according to the representation in FIG. 3—depending on the location within the two-dimensional data set D to which they relate—to a corresponding location of the rolling material 2. The surface of the rolling material 2 is thus mapped onto the locations of the data set D. The respective data value DW as such is dependent in particular on the external flatness of the rolling material 2 that prevails locally at the respective corresponding location of the rolling material 2. Optionally, the respective data value DW as such can additionally be dependent on the internal stress of the rolling material 2 that prevails locally at the respective corresponding location of the rolling material 2.

The roller assembly further has an evaluation device 9. The evaluation device 9 is connected for data transfer to the acquisition device 8. As a result of the connection for data transfer, the evaluation device 9 is able to receive the data sets D from the acquisition device 8. The construction and the principle of operation of the evaluation device 9 are the core subject matter of the present invention.

The evaluation device 9 is generally in the form of a software-programmable device. This is indicated in FIG. 1 by “μP” within the evaluation device 9. The evaluation device 9 is programed with a computer program 10. The computer program 10 comprises machine code 11 which can be processed directly by the evaluation device 9. As a result of programing with the computer program 10, or as a result of the processing of the machine code 11, the evaluation device 9 performs the sequence of steps explained hereinbelow in conjunction with FIG. 4.

In a step S1, the evaluation device 9 receives the respective data set D (or optionally also a plurality of data sets D) from the acquisition device 8.

In a step S2, the evaluation device 9 performs pre-processing of the data set D. Step S2 is only optional. It may thus also be omitted. For this reason, step S2 is shown only by a broken line in FIG. 3.

In a step S3, the evaluation device 9 divides the data set D into strips 12 (see FIG. 3, in which one of the strips 12 is shown). As is apparent, the strips 12 (or the regions of the rolling material 2 that correspond to the strips 12) run in the transport direction x. The strips 12 can have the same width as one another. This is also mostly the case. However, it is not absolutely essential.

In a step S4, the evaluation device 9 performs-individually for the respective strip 12—in the transport direction x-a local frequency analysis of the corresponding strip 12. For example, the evaluation device 9 can perform a Fourier transform in step S4, indicated in FIG. 4 by “FOU”. In any case, however, the evaluation device 9 determines by means of the frequency analysis the intensities of local oscillations and their respective spatial frequency, thus ultimately also the local spectrum.

On the basis of the local frequency analysis, and thus by means of the local frequency analysis, the evaluation device 9 determines in a step S5—again individually for the respective strip 12-a respective error value PF. The evaluation device 9 thus evaluates the local spectrum determined for the respective strip 12.

As a result of the mapping rule in the acquisition of the data set D, the strips 12 of the data set D correspond to corresponding strips 13 of the rolling material 2. One of the strips 13 is shown in FIG. 2. As a result of the given correspondence between the strips 12 and the strips 13, the error values PF can thus also be allocated directly to the corresponding strips 13 of the rolling material 2.

As already mentioned, it is possible that generally acting flatness control elements 5 and/or only locally acting flatness control elements 6 are present. If only generally acting flatness control elements 5 are present, the number of strips 12 can be determined as required. This is in principle likewise possible if-solely or inter alia-only locally acting flatness control elements 6 are present, which act only on a respective portion of a working roller 3. However, in this case the strips 12 are preferably determined such that the corresponding strips 13 of the rolling material 2 each correspond according to the illustration in FIG. 2 to such a portion of the upper working roller 3 and/or of the lower working roller 3. The term “correspond” is not necessarily to be understood in the sense of a 1:1 correspondence in this connection. Rather, the term is meant such that an individual strip 12/13 can be associated with exactly one portion, the corresponding individual strip 12/13 is thus not simultaneously part of a plurality of portions. Conversely, it is, however, entirely possible that a plurality of strips 12/13 fall within an individual portion.

The flatness error of the rolling material 2 is defined as δL/L, wherein L is the minimum length of the respective corresponding strip 13 of the rolling material 2 in the stress-free state and δL is the difference by which the respective strip 13 of the rolling material 2 is longer than the minimum length. The error value PF is generally not identical to the flatness error but is dependent thereon.

In a step S6, the evaluation device 9 therefore supplies the determined error values PF to a control device 14. For this purpose, the evaluation device 9 is connected for data transfer to the control device 14—see also FIG. 1.

The control device 14 is likewise part of the roller assembly. The control device 14 takes the error values PF transmitted thereto into consideration in the determination of control variables S for the flatness control elements 5, 6 of the roll stand 1. The error values are taken into consideration in such a manner that the error values PF are corrected as far as possible, that is to say the resulting flatness of the rolling material 2 is brought as close to a desired flatness as possible. The control device 14 outputs the control variables S to the flatness control elements 5, 6.

From step S6, the evaluation device 9 returns to step S1 again. The evaluation device 9 thus performs steps S1 to S6 iteratively repeatedly. Generally, the steps are performed with the fixed cycle time T. This cycle time T should preferably not exceed the control frequency of the control device 14.

Ultimately, the cooperation of the acquisition device 8, the evaluation device 9, the control device 14 and the roll stand 1 (or the flatness control elements 5, 6 thereof) results in a closed feedback control loop which works in real time and by means of which the error values PF can be corrected and eliminated as far as possible.

The acquisition range of the acquisition device 8 is preferably determined such that, according to the illustration in FIG. 5, the surface of the rolling material 2 is acquired over the entire width b of the rolling material 2 by means of the two-dimensional data sets D. Thus, the respective two-dimensional data set D also includes the lateral edges 15 of the rolling material 2 (or the image thereof).

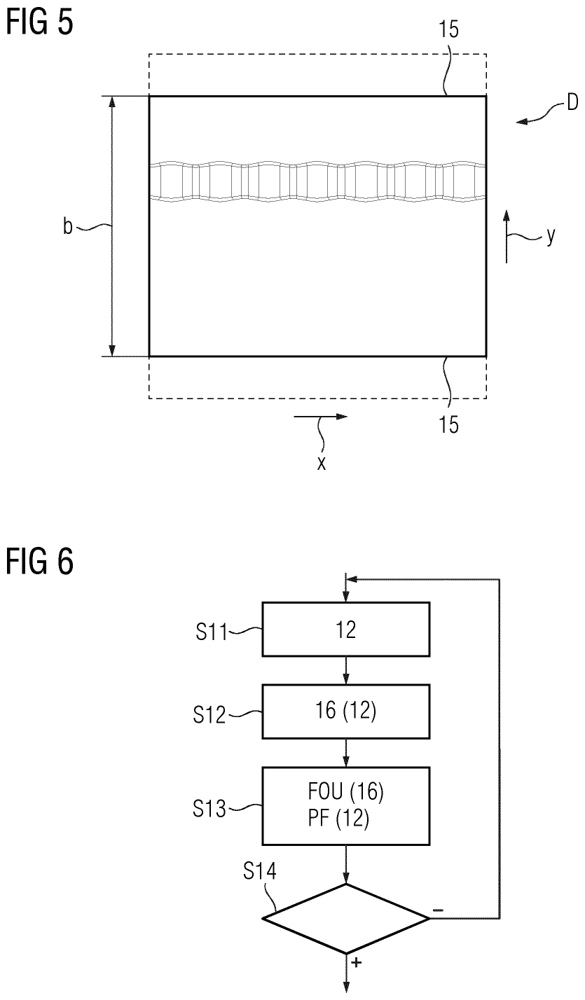

A possible procedure by means of which the frequency analysis and the determination, based thereon, of the error value PF can be carried out will be described hereinbelow in conjunction with FIG. 6. FIG. 6 thus shows a possible implementation of steps S4 and S5 of FIG. 4.

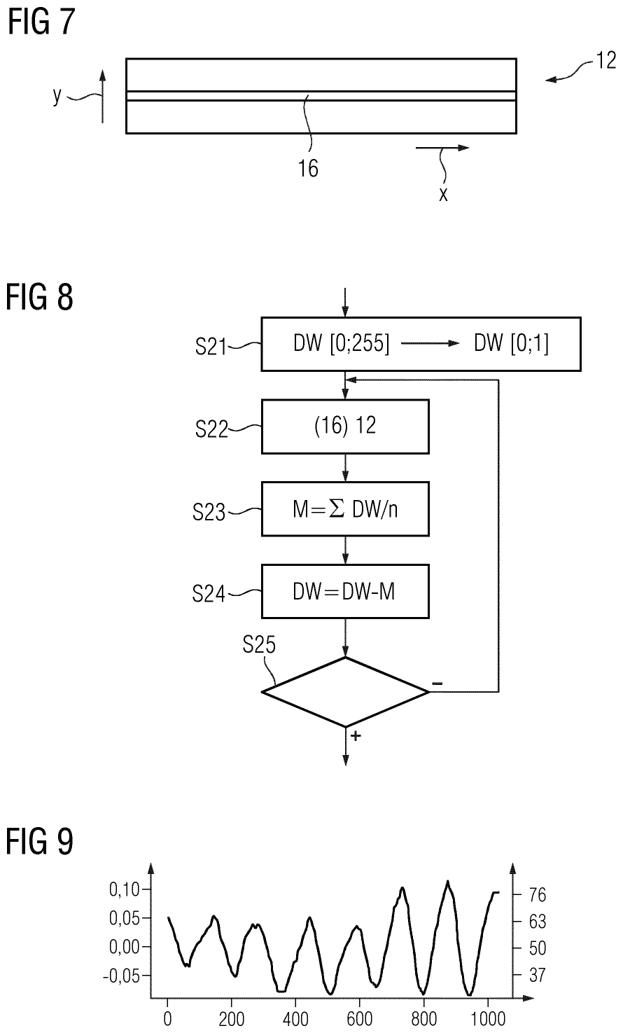

According to FIG. 6, in a step S11 the evaluation device 9 selects one of the strips 12. In a step S12, the evaluation device 9 selects a segment 16 of the strip 12 selected in step S11. According to FIG. 7, the segment 16 extends, when seen in the transport direction x, over the entire length of the strip 12 selected in step S11. By contrast, when seen in the width direction y, the segment 16 extends only over part of the width of the strip 12 selected in step S11. In step S13, the evaluation device 9 carries out the frequency analysis (see step S4) with the data values DW of only that segment 16 and, on the basis thereof, determines (see step S5) the error value PF for the strip 12 selected in step S11.

Generally, the procedure of FIG. 6 yields better results, the narrower the segment selected in step S12 in the width direction y. In an extreme case, it is possible that the segment 16 extends in the width direction y only over a single line of the two-dimensional data set D.

In a step S14, the evaluation device 9 checks whether it has already carried out steps S11 to S13 for all the strips 12. If this is not the case, the evaluation device 9 returns to step S11. In this case, when it performs step S11 again, it selects a different strip 12, for which it has not yet performed steps S11 to S13. Otherwise, the procedure of FIG. 6 is complete.

It is even possible within the scope of the embodiment of FIGS. 6 and 7 that the evaluation device 9 selects a plurality of segments 16 for an individual strip 12. In this case, the evaluation device 9 evaluates the segments 16 individually and then determines the error value PF for the corresponding strip 12 on the basis of the results of the evaluation of the individual segments 16. For example, the evaluation device 9 can determine a preliminary error value for each of the segments 16 and then determine the resulting error value PF on the basis of the preliminary error values. In particular, the evaluation device 9 can use the maximum preliminary error value or a weighted or unweighted mean of the determined preliminary error values as the resulting error value PF.

The pre-processing mentioned in step S2 can be carried out if required. Possible procedures have already been explained. A further possible pre-processing will be explained in greater detail hereinbelow in conjunction with FIG. 8. This pre-processing can be performed, as required, as an alternative or in addition to the other possibilities for pre-processing.

It is assumed within the scope of FIG. 8 that the respective data set D is a “normal” intensity image (grayscale image) of the rolling material 2. The data values DW are thus intensity values. In this case, according to the illustration in FIG. 8, there can first be carried out, for example, in a step S21 a normalization of the intensity values in respect of the maximum possible value range of the values of the two-dimensional data set D, that is to say a—mostly linear—mapping into the value range between 0 and 1. If—purely by way of example—the data values DW are gray values with a data depth of 8 bits, that is to say the data values DW can lie between 0 (=black) and 255 (=white), then a data value DW of 0 is allocated, unchanged, the value 0, but a data value DW of 1 is allocated the value 1/255, a data value DW of 2 is allocated the value 2/255, etc. Step S21 can be performed simultaneously across all the strips 12 since it is independent of the positioning of a data value DW within the data set D. The newly determined data values DW, that is to say the values in the range between 0 and 1, subsequently appear in place of the original data values DW, that is to say, for example, the values between 0 and 255.

In a step S22, the evaluation device 9 selects a region of the data set D. This region can be a strip 12 or, in the case of the (preferred) embodiment according to FIGS. 6 and 7, the segment 16 within a strip 12. In a step S23, the evaluation device 9 determines the mean M of the data values DW for the region selected in step S22. The evaluation device 9 thus forms the sum of the data values DW and divides this sum by the number n of data values DW in the sum. In a step S24, the evaluation device 9 subtracts the mean M from the data values DW of the region selected in step S22.

In a step S25, the evaluation device 9 checks whether it has already carried out steps S22 to S24 for all the strips 12. If this is not the case, the evaluation device 9 returns to step S22. In this case, it selects a different region, for which it has not yet performed steps S22 to S24, when it performs step S22 again. Otherwise, the procedure of FIG. 8 is complete.

The repeated performance of steps S22 to S25 thus effects, based on a strip 12 or the segment 16 of a strip 12, adjustment by the mean M of the data values DW of the respective strip 12 or segment 16.

The procedure of FIG. 8 is also apparent from the illustration in FIG. 9. FIG. 9 shows—purely by way of example—a profile of the data values DW in the transport direction x of a segment 16 of minimal width in the width direction y. The scaling of the data values DW after steps S21 to S25 have been performed is shown on the left in FIG. 9, and the scaling of the data values DW before steps S21 to S25 are performed is shown on the right. The numbers on the abscissa can be, for example, cell numbers in the transport direction x.

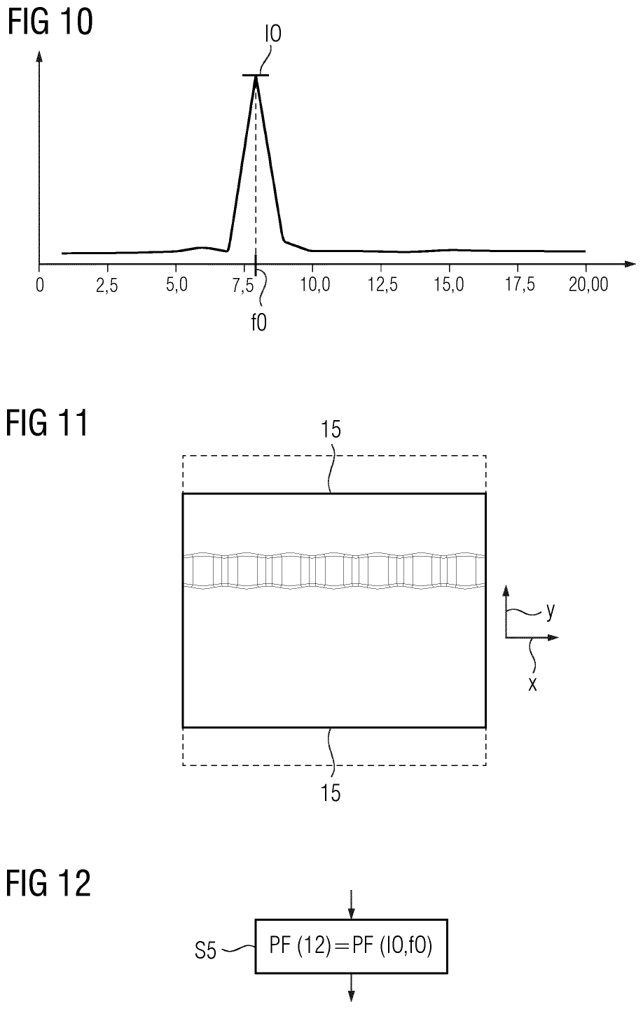

FIG. 10 shows, purely by way of example, a typical spectrum in the local region, as has been obtained, for example, for an individual strip 12 by performing steps S4 and S5. The number of oscillations per meter, for example, can be plotted on the abscissa, and the associated intensity of the frequency in arbitrary units can be plotted on the ordinate. According to the illustration in FIG. 10, the spectrum has a (1) significant peak, that is to say a highest intensity I0. This is the case in particular because the associated waves in the rolling material 2—see FIG. 11—are often very regular in the case where a lack of flatness occurs.

The highest intensity I0 occurs at an associated spatial frequency f0. Preferably, according to the illustration in FIG. 12, the evaluation device 9 determines the error value PF for the corresponding strip 12 using the highest intensity I0 and/or the associated spatial frequency f0. It is possible that only the highest intensity I0 and/or the associated frequency f0 are used in the determination of the error value PF. In the simplest case, for example, only the highest intensity I0 can be used. Alternatively, only the spatial frequency f0 of the greatest local oscillation can be used. Preferably, however, the respective error value PF is determined on the basis of the highest intensity I0 and the associated spatial frequency f0 in combination. Alternatively, it is possible that other intensities and/or the respective associated spatial frequencies are used in the determination of the error value PF. In any case, it is possible to store corresponding (one-dimensional) characteristic curves or (multi-dimensional) sets characteristic curves in the evaluation device 9.

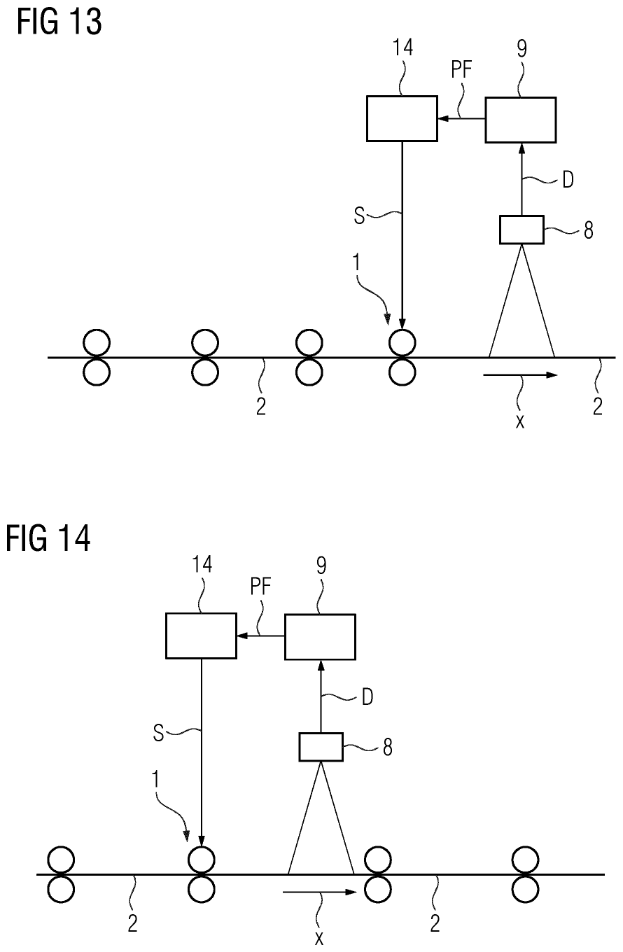

It is possible that the roll stand 1 of the roller assembly according to the invention is the only roll stand of a rolling mill. Alternatively, the roll stand 1 of the roller assembly according to the invention can be part of a multi-stand rolling-mill train. In this case, the roll stand 1 of the roller assembly according to the invention can either be, according to the (simplified) illustration in FIG. 13, the last roll stand of the multi-stand rolling-mill train or, according to the (likewise simplified) illustration in FIG. 14, a roll stand other than the last roll stand of the multi-stand rolling-mill train. In both cases, however, there is no other roll stand between the roll stand 1 of the roller assembly according to the invention and the acquisition device 8.

The present invention has many advantages. In particular, the acquisition device 8 is simple, robust and inexpensive. A compact and space-saving installation is possible. It is further possible to arrange the acquisition device 8 at a sufficiently great distance from the rolling material 2, so that the loading of the acquisition device 8 with dust, water, heat, etc. is relatively low. The construction modular. Individual components, in particular the acquisition device 8, the evaluation device 9 and the control device 14, can therefore be modified and exchanged. Only the interfaces of the exchanged components have to be compatible.

Although the invention has been illustrated and described in detail by the preferred exemplary embodiment, the invention is not limited by the disclosed examples and other variants can be derived therefrom by the person skilled in the art without departing from the scope of protection of the invention.

### LIST OF REFERENCE SIGNS

1 roll stand
2 rolling material
3 working rollers
4 further rollers
5 flatness control elements
6 control elements
7 coolant
8 acquisition device
9 evaluation device
10 computer program
11 machine code
12 strip
13 strip
14 control device
15 lateral edges
16 segment
b rolling material width
D data set
DW data values
f0 spatial frequency of the highest intensity
I0 highest intensity
M mean
PF error value
S control variables
S1 to S25 steps
T cycle time
X transport direction
y width direction

1. An operating method for a roller assembly,
wherein a planar rolling material of metal which extends in a width direction (y) over a rolling material width (b) is rolled by means of a roll stand of the roller assembly, wherein the planar rolling material leaves the roll stand in a transport direction (x) after it has been rolled,
wherein at least one two-dimensional data set (D) of the surface of the planar rolling material is iteratively repeatedly acquired on the output side of the roll stand-by means of an acquisition device which works contactlessly and without mechanical action on the planar rolling material, the values (DW) of which data set are dependent at least on the external flatness prevailing locally at the respective corresponding location of the planar rolling material,
wherein the respective two-dimensional data set (D) is received by an evaluation device of the roller assembly, which evaluation device, for strips of the planar rolling material running in the transport direction (x), and using strips of the respective two-dimensional data set (D) that correspond to the strips, determines an error value (PF) which relates to the respective strip and is dependent on the flatness error,
wherein the evaluation device supplies the determined error values (PF) to a control device of the roller assembly, which in turn takes the determined error values (PF) into consideration in the determination of control variables(S) for flatness control elements of the roll stand,
so that, as a result of the cooperation of the acquisition device, the evaluation device, the control device and the roll stand, a closed feedback control loop which works in real time is obtained, wherein
the evaluation device, for determining the respective error value (PF) of a strip, determines intensities and spatial frequencies of local oscillations of the data values of the strip of the respective two-dimensional data set (D) that corresponds to the respective strip and determines the respective error value (PF) on the basis of the intensities and/or the spatial frequencies.

2. The operating method as claimed in claim 1, wherein
the acquisition device is in the form of a camera device by means of which a respective two-dimensional image of the surface of the planar rolling material is acquired as the respective two-dimensional data set (D) or is determined on the basis of acquired image data.

3. The operating method as claimed in claim 1, wherein,
by means of the two-dimensional data sets (D), the surface of the planar rolling material is acquired over the entire width (b) of the planar rolling material.

4. The operating method as claimed in claim 1, wherein
the acquisition device, when seen in a plane defined by the width direction (y) and the transport direction (x), is arranged centrally above the planar rolling material.

5. The operating method as claimed in claim 1, wherein
the flatness control elements of the roll stand comprise locally acting control elements by means of which in each case only a portion of the upper working roller and/or of the lower working roller is influenced, and in that the strips of the planar rolling material each correspond to a portion of the upper working roller and/or of the lower working roller.

6. The operating method as claimed in claim 1, wherein
the evaluation device, for determining the respective error value (PF) of a strip, selects a segment of the respective strip, in that the segment, when seen in the transport direction (x) of the planar rolling material, extends over the entire length of the respective strip and, when seen in the width direction (y) of the planar rolling material, extends over only part of the width of the respective strip, and in that the evaluation device determines the intensities and the spatial frequencies only in respect of the segment of the respective strip.

7. The operating method as claimed in claim 1, wherein
the evaluation device carries out pre-processing of the respective two-dimensional data set (D) prior to the determination of the intensities and spatial frequencies.

8. The operating method as claimed in claim 7, wherein
the data values (D) are intensity values, and the pre-processing comprises normalization of the intensity values in respect of the maximum possible value range of the values of the two-dimensional data set (D) and, based on the respective strip or a segment of the respective strip, adjustment by the mean (M) of the data values (DW) of the respective strip or segment.

9. The operating method as claimed in claim 1, wherein
the evaluation device determines the respective error value (PF) using at least the intensity (I0) and/or the spatial frequency (f0) of the greatest local oscillation.

10. The operating method as claimed in claim 1, wherein
the planar rolling material is hot rolled or is cold rolled in the roll stand.

11. The operating method as claimed in claim 1, wherein
that there is no other roll stand between the roll stand of the roller assembly and the acquisition device.

12. The operating method as claimed in claim 11, wherein
the roll stand of the roller assembly is the only roll stand of a rolling mill, the last roll stand of a multi-stand rolling-mill train, or a roll stand other than the last roll stand of a multi-stand rolling-mill train.

13. A computer product comprising a non-transitory computer-readable medium storing a program, wherein the program comprises machine code which can be processed directly by an evaluation device of a roller assembly, wherein the processing of the machine code by the evaluation device has the effect that the evaluation device, during operation of a roll stand in which a planar rolling material of metal is rolled and from which the planar rolling material exits in a transport direction (x) after it has been rolled, cooperates with a control device of the roll stand and with an acquisition device which works contactlessly and without mechanical action on the planar rolling material, such that it iteratively repeatedly
receives from the acquisition device at least one two-dimensional data set (D), acquired by the acquisition device, of the surface of the planar rolling material on the output side of the roll stand, wherein the values (DW) of the respective two-dimensional data set (D) are dependent at least on the external flatness prevailing locally at the respective corresponding location of the planar rolling material,
determines, for strips of the planar rolling material running in the transport direction (x), and using strips of the respective two-dimensional data set (D) that correspond to the strips, an error value (PF) which relates to the respective strip and is dependent on the flatness error, and
supplies the determined error values (PF) to the control device for consideration in the determination of control variables(S) for flatness control elements of the roll stand, so that, as a result of the cooperation of the acquisition device, the evaluation device and the control device, a closed feedback control loop which works in real time is obtained, wherein the evaluation device, for determining the respective error value (PF) of a strip, determines intensities and spatial frequencies of local oscillations of the data values of the strip of the respective two-dimensional data set (D) that corresponds to the respective strip and determines the respective error value (PF) on the basis of the intensities and/or spatial frequencies.

14. The computer program as claimed in claim 13, wherein the evaluation device performs one of a)-d), some of a)-d), or all of a)-d),
a) selects a segment of the respective strip, in the segment, when seen in the transport direction (x) of the planar rolling material, extends over the entire length of the respective strip and when seen in the width direction (y) of the planar rolling material, extends over only part of the width of the respective strip, and determines the intensities and the spatial frequencies only in respect of the segment of the respective strip,
b) carries out pre-processing of the respective two-dimensional data set (D) prior to the determination of the intensities and spatial frequencies,
c) carries out pre-processing of the respective two-dimensional data set (D) prior to the determination of the intensities and spacial frequencies, wherein the data values (D) are intensity values, and in that the pre-processing comprises normalization of the intensity values in respect of the maximum possible value range of the values of the two-dimensional data set (D) and, based on the respective strip or a segment of the respective strip, adjustment by the mean (M) of the data values (DW) of the respective strip or segment,
d) determines the respective error value (PF) using at least the intensity (I0) and/or the spacial frequency (f0) of the greatest local oscillation.

15. An evaluation device of a roller assembly, wherein the evaluation device is programed so that the evaluation device cooperates with an acquisition device and with a control device of a roll stand of a roller assembly in accordance with an operating method as claimed in claim 1.

16. A roller assembly,
wherein the roller assembly has a roll stand which comprises flatness control elements and by means of which a planar rolling material of metal which extends in a width direction (y) over a rolling material width (b) is rolled and is guided out of the roll stand in a transport direction (x) after it has been rolled,
wherein the roller assembly has an acquisition device which works contactlessly and without mechanical action on the planar rolling material and by means of which at least one two-dimensional data set (D) of the surface of the planar rolling material is iteratively repeatedly acquired on the output side of the roll stand, the data values (DW) of which data set are dependent at least on the external flatness prevailing locally at the respective corresponding location of the planar rolling material,
the roller assembly has an evaluation device as claimed in claim 15 which is connected for data transfer to the acquisition device for the repeated receiving of two-dimensional data sets (D), acquired by means of the acquisition device, of the surface of the planar rolling material and which determines, for strips of the planar rolling material running in the transport direction (x), and using strips of the respective two-dimensional data set (D) that correspond to the strips, an error value (PF) which relates to the respective strip and is dependent on the flatness error, and supplies the determined error values (PF) to a control device of the roller assembly,
wherein the control device takes the determined error values (PF) into consideration in the determination of control variables(S) for the flatness control elements of the roll stand.
